(19) United States
(12) Patent Application Publication
(10) Pub. No.: US 2007/0004549 A1
(43) Pub. Date: Jan. 4, 2007

(54) Transmission system

(76) Inventors: Steve W. Chryssochoos, East Quogue, NY (US); Frank Cerasuola, Manorville, NY (US)

Correspondence Address: LILLIE LAW, LLC, 269 SOUTHPORT ST, RONKONKOMA, NY, 11779, US

(21) Appl. No.: 11/174,179

(22) Filed: Jul. 1, 2005

(51) Int. Cl. F16H 48/06

(52) U.S. Cl. 475/149

(57) ABSTRACT

An improved transmission system comprising a body substantially cylindrical in shape and having a plurality of chambers about the center of the body; configured and dimensioned to be cooperatively connected between a steering column and a steering wheel; a group of paddle assemblies cooperatively connected to the body within a chamber having a switch therein; the body further having a cover cooperatively connected about a portion of the paddle assembly, the body providing a portal for a portion of the paddle assembly to pass outwardly therethrough which further provides a governing means defining the range of motion of the paddle assembly; wherein the switch is configured and dimension to cooperatively function with the paddle assembly, and a transmitting means integrated with the body for communicating wirelessly with a receiving means cooperatively connected to the computer controlling the vehicle's transmission.

### BACKGROUND OF THE INVENTION

This invention relates to a transmission system for use in vehicles, particularly, an improved transmission system for use in older vehicles. The automotive aftermarket is a robust and thriving industry that provides goods and services to prospective customers, typically automotive enthusiasts, thereby better enabling end users to customize so as to personalize their mainstream vehicles. Aftermarket parts are generally designed to replace existing mass-produced parts in an effort to enhance particular characteristics including, inter alia, comfort, mileage, performance, reliability, style, and the like. Such aftermarket parts must be pragmatically adaptable to a certain degree, that each aftermarket part duplicates the original part. For example, various specifications or attributes of the OEM part are incorporated, while others are not, thereby providing personalization.

The existence of aftermarket parts is of even greater importance to consumers with respect to vehicles that are no longer produced, whether or not it is an OEM design or a modified design of an OEM part. A contemporary example of an aftermarket part is an electronic transmission controller, such controllers generally allow the adaptation of modern electronic transmissions into older cars, and typically include a feature known as manumatic shifting technology. Moreover, car enthusiasts typically are concerned when modifying their vehicles, from both an aesthetics point of view, and from an installation point of view. It is of particular importance when retrofitting a vehicle's system that encounters electrical systems. For example, when modifying a steering column and transmission interface, adding additional hardwiring presents, inter alia, two safety problems because, in part, the steering wheel rotates independently of the column. Thus increasing the number of wires to a steering column increases the likelihood that such wires would become entangled with the steering shaft precipitating loss of control of the vehicle. Although attempts have been made to address this issue, namely “clock springs” and “slip rings,” the end user would still have to modify the steering column via, inter alia, drilling to accept such parts. Secondly, the undertaking drilling the steering column to incorporate such parts creates the possibility of metal shavings falling into the column, and if the shavings remain undetected, the shavings are likely to cause binding and/or premature wear, both safety concerns.

Moreover, others have incorporated various devices into the steering wheel, for example, buttons, for various functionality, such as a horn, cruise control features, radio and/or telephone controls and the like. Such buttons have been positioned such that the thumb or entire hand is required to be separated from the steering wheel, even momentarily, to activate, deactivate, engage, disengage (hereafter activate), thereby increasing the likelihood of operator error in driving. Furthermore, sometimes even the driver's eyesight must be redirected from the road to the steering area so as to select which device to activate, thereby compounding the issue. Hence, it would be beneficial to provide an improved transmission system, which is wireless, and of relatively noncomplex construction, inexpensive to manufacture, in addition to increasing the ease of installation and use thereof, while ensuring safety, and while harmonizing these objectives including optimization of ergonomics, and existing technology such as the onboard computer system.

### SUMMARY OF THE INVENTION

The subject invention is directed to a new and unique transmission system that includes a body substantially cylindrical in shape and having a plurality of chambers about the center of said body; and configured and dimensioned to be cooperatively connected between a steering column and a steering wheel; a group of first and second paddle assemblies, wherein each assembly is cooperatively connected to said body within a chamber having a switch therein; said body further having a cover cooperatively connected about at least a portion of said paddle assembly, and optionally, a spring positioned between said cover and said paddle assembly, said body providing a portal for at least a portion of said paddle assembly to pass outwardly therethrough which further provides a governing means defining the range of motion of said paddle assembly; wherein, optionally, one paddle assembly is configured to shift to a higher gear, and another paddle assembly to downshift; wherein said switch is configured and dimension to cooperatively function with said paddle assembly, and a transmitting means integrated with said body for communicating wirelessly with a receiving means cooperatively connected to the computer controlling the vehicle's transmission.

It is an objective of the present invention to provide an improved ergonomic shifting device.

It is another objective of the present invention to provide an improved transmission device that is wireless.

It is a further objective of the present invention to provide an improved transmission device that reduces labour and materials to incorporate the device into a vehicle while simultaneously increasing safety during operation thereof.

A further objective of the present invention is to provide an improved transmission device which retrofits vehicles.

It is a still further objective of the present invention to provide an improved transmission device which includes a selection, inter alia, between automatic and manu-matic modes of operation.

Another objective of the present invention is to provide an improved transmission device having an aesthetically clean and pleasing design.

Other objectives, advantages, and novel features of the present invention will become more apparent from the following detailed description when taken in conjunction with the accompanying drawings set forth hereinbelow.

### BRIEF DESCRIPTION OF THE DRAWINGS

The following drawings, in which like reference characters indicate like parts, are provided for illustration of the invention and are not intended to limit the invention in any manner whatsoever.

FIG. 1 is an exploded front view of a preferred embodiment of the present invention;

FIG. 2 is a top view of a preferred embodiment of the present invention;

FIG. 3 is a side view of a preferred embodiment of the present invention;

FIG. 4 is an exploded side view of a preferred embodiment of the present invention;

FIG. 5 is a block diagram of a preferred embodiment of the present invention, illustrating the interrelation between the communication means and the receiving means; and

FIG. 6 is a schematic of a preferred embodiment of the present invention, more particularly, a schematic of a receiving means, the transmission controller, and connection to the onboard computer system.

### DETAILED DESCRIPTION OF THE INVENTION

The following descriptions of the preferred embodiments are presented to illustrate the present invention and are not to be construed to limit the claims in any manner whatsoever.

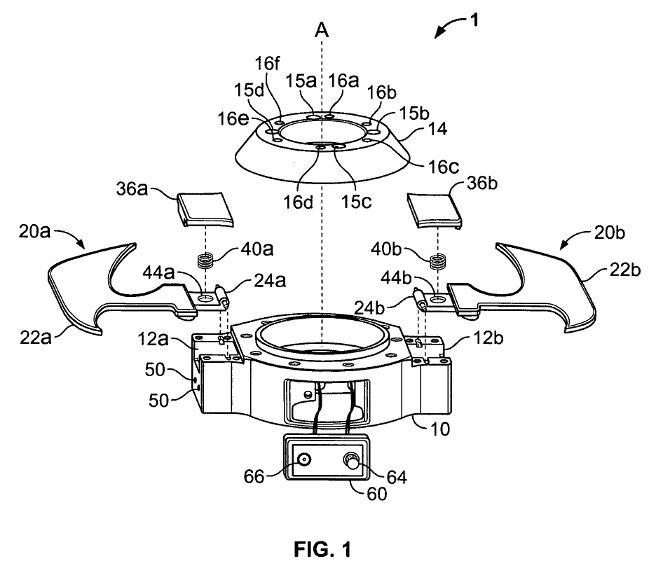

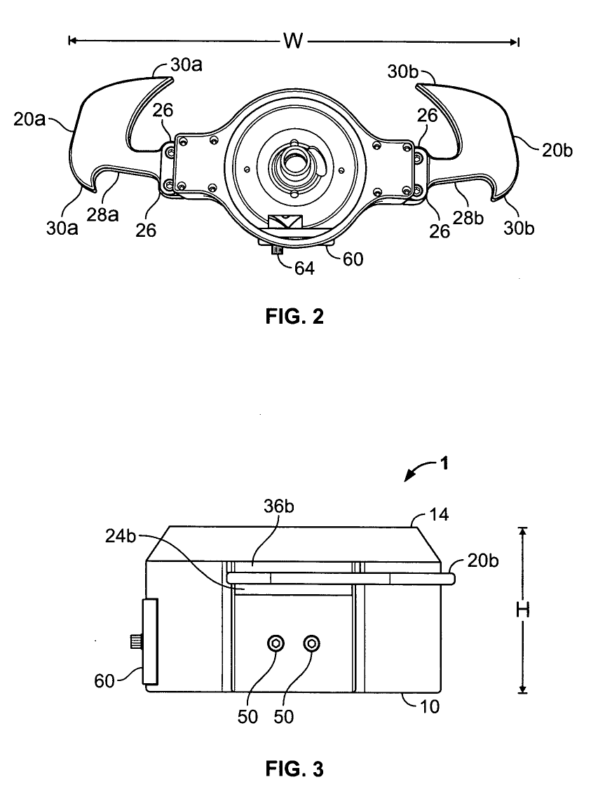

Referring now to the drawings wherein like reference numerals identify similar structural elements of the system set forth herein, is illustrated by FIGS. 1 to 6, namely, an improved transmission system 1 having a body 10, a group of paddles assemblies 20a, 20b, and a wireless communication means 60 for communicating between said system 1 and the onboard computer system which control's the vehicle's transmission.

In a preferred embodiment, the body 10 is substantially cylindrical in shape, having a height H and an outside diameter OD. Moreover, the body 10 further includes a plurality of chambers 12a, 12b about the center of said body 10 wherein an axis A extends vertically therethrough, and is configured and dimensioned to be cooperatively connected between a steering column and a steering wheel (not shown), wherein the center of the body 10 is aligned with the common axis of the steering column and steering wheel. The body 10 further comprises a steering wheel adaptor ring 14 releasably mounted to said body 10, preferably via threaded fasteners (not shown), wherein the adaptor ring includes a plurality of holes 15a-15d sufficiently sized and spaced forming a pattern about the ring 14 to receive the threaded fasteners. The adaptor ring 14 further includes a plurality of holes 16a-16e sufficiently sized and spaced forming a pattern about the ring 14 to receive a particular steering wheel and threaded fasteners to mount such steering wheel to the adaptor ring (not shown) via plurality of holes 16a-16e. It is envisioned that one adaptor ring 14 may include multiple patterns such that one adaptor ring 14 may be used with a plurality of makes and/or models of steering wheels. Additionally, the body 10 is made from a material that has one or more of the following characteristics, namely, is lightweight, a metal, preferably an aluminum based material, most preferably 6061 aluminum, heat treated to a T6 condition.

The system 1 further having a group 20 of first and second paddle assemblies 20a, 20b defining the overall width W of the system 1, which is preferably less than or equal to the overall width of the steering wheel to be utilized in cooperation therewith, and positioned about 180 degrees from each other. However, it is preferred, that the paddles assemblies 20a, 20b emanate from the central hub in a 9 o'clock and 3 o'clock position, and optionally, extend to the 10 o'clock and 2 o'clock positions. Each assembly 20a, 20b includes a paddle portion 22a, 22b and a hinge portion 24a, 24b optionally; these portions 22a, 22b, and 24a, 24b may be separate and distinct parts that are interconnected together, preferably via threaded fasteners 26. Moreover, the paddle portions 22a, 22b may also be interchangeable having different aesthetic features. For example, they 22a, 22b may have different shapes, with each having ergonomic friendly elements incorporated therewith. In a preferred embodiment, the ergonomic elements include a leg section 28a, 28b, a heel section 30a, 30b, and a toe section 32a, 32b. Nonetheless, each assembly 20a, 20b is preferably made from the same material as the body 10, and is cooperatively connected to said body 10 within a chamber 12a, 12b having a switch 34a, 34b therein.

The body 10 further having a cover 36a, 36b cooperatively connected about at least a portion of said paddle assembly 20a, 20b, and optionally, a spring 40a, 40b positioned between said cover 36a, 36b and said paddle assembly 20a, 20b, wherein each end of said spring 40a, 40b is positioned in a recess, a first end positioned in a recess 42a, 42b on the inside of said cover 36a, 36b, and a second end positioned in a recess 44a, 44b of said paddle assembly (not shown). The body 10 further providing a portal 46a, 46b for at least a portion of said paddle assembly 20a, 20b to pass outwardly therethrough within a plane perpendicular to said axis A; and which further provides a governing means defining the range of motion of said paddle assembly 20a, 20b; preferably wherein the upmost position of an assembly 20a, 20b is substantially parallel to the plane of the body 10, as illustrated in FIGS. 1, 3 and 4. Field testing was used to determine the ideal paddle to steering wheel distance, for example, in a preferred embodiment, the range of distance therebetween is about two (2) inches to about three-eighths (⅜) of an inch, more preferably in the range of about one (1) inch to about three-quarters (¾) of an inch, while in the neutral position.

Optionally, one paddle assembly is electronically configured to downshift; and another paddle assembly to shift to a higher gear, for example 20a, 20b respectively; although, it is envisioned that the paddle assemblies 20a, 20b may be electronically configured inversely, for example, 20b, 20a, respectively, yet the former example and selection of connection is preferred. Moreover, in a preferred embodiment, the group of paddle assemblies 20 selection is limited to forward gears while the vehicle is at speed, so as to maintain safety via preventing shifting into non-forward gears while at speed.

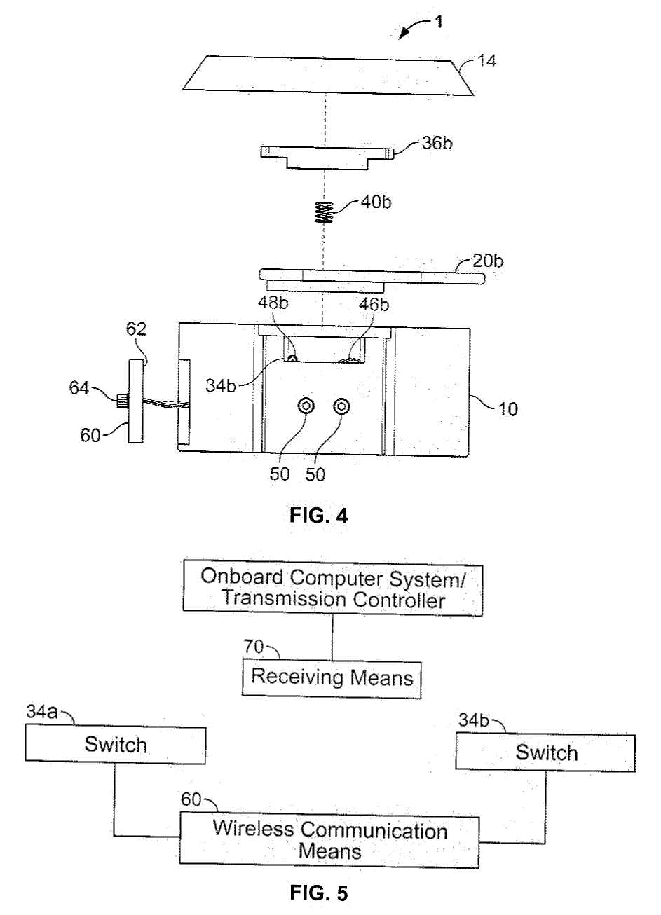

Furthermore, the switch 34a, 34b is configured and dimensioned to cooperatively function with said paddle assembly 20a, 20b. By way of example, and best illustrated in FIGS. 1 and 4 collectively; the switch 34a, 34b, a lever or rocker switch having a roller 48a, 48b on the end of the lever, is positioned and affixed within the chamber 12a, 12b, preferably via fasters 50, such that the roller 48a, 48b contacts the underside of the paddle assembly 20a, 20b when in the downmost position (not shown) and does not when in the upmost position (illustrated in FIGS. 1, 3 and 4).

The system 1 further including a wireless communication means 60 for communicating between said system 1 and the onboard computer system which controls the vehicle's transmission/drive train (not shown). The wireless communication means 60 includes a transmitting means 62 integrated with said body 10 for communicating wirelessly with a receiving means 70 cooperatively connected to the computer controlling the vehicle's transmission/drive train (not shown). In a preferred embodiment, the transmitting means 62 includes a battery, and optionally, a LED test light 64 cooperatively connected together, which is incorporated in the body 10 of the system 1, in this case via a threaded fastener 66. Furthermore, the transmitting means 62 is a two-channel RF transmitter, with a frequency range of 100 to 1,000 MHz, preferably with range of about 250 to 750 MHz, most preferably with a range of about 300 to 600 MHz. For example, the SK-919TD2A manufactured by SECO-LARM® may be incorporated herewith.

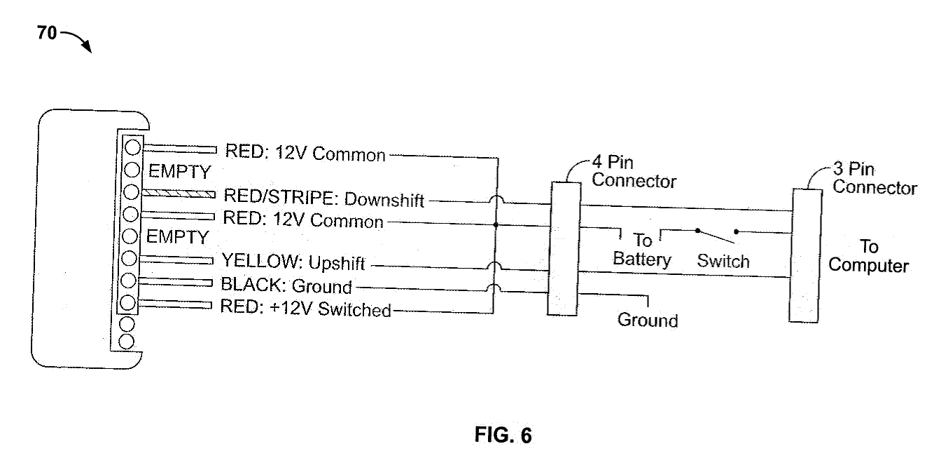

The receiving means 70 includes a switching means for selection of a driving mode, namely, automatic, or manu-matic. Wherein, when the switching means is in manu-matic mode, the receiving means 70 is activated to act on the instructions sent by said wireless communication means 60, conversely, when the switching means is in automatic mode, the receiving means 70 does not act on the instructions. More particularly, the receiving means 70 may be a two-channel RF receiver, such as the SK-910R2 manufactured by SECO-LARM®, wherein said receiving means 70 operatively interacts with said wireless communications means 60 set forth herein above. However, due to safety concerns, so as to not interfere between two adjacent vehicles, the desired range of broadcast and reception thereof may be limited, and/or unique codes and/or rolling codes may be assigned therebetween to reduce the likelihood of controlling another's vehicle. Moreover, the receiver 70 can be mounted anywhere on the vehicle, and is powered by the vehicle. It is preferred that signal transmission time be limited to no more than about an eighth of a second (0.125 sec). It is envisioned that other technologies may be incorporated herewith to reduce the likelihood or eliminate such risks. Nonetheless, FIG. 6 illustrates an example of said receiving means 70 wherein the SK-910R2 is cooperatively connected to the preexisting onboard computer system via a three (3) pin Packard Metripak™ wherein, optionally, a switch is operatively incorporated therebetween providing the end user to improve safety by enabling/disenabling the system 1 as desired.

All of the above referenced patents; patent applications and publications are hereby incorporated by reference. Many variations of the present invention will suggest themselves to those of ordinary skill in the art in light of the above detailed description. All such obvious modifications are within the full-intended spirit and scope of the claims of the present application.

What is claimed is:

1. An improved transmission system comprising:
a body substantially cylindrical in shape and having a plurality of chambers about the center of said body; and configured and dimensioned to be cooperatively connected between a steering column and a steering wheel;
a group of first and second paddle assemblies, wherein each assembly is cooperatively connected to said body within a chamber having a switch therein; said body further having a cover cooperatively connected about at least a portion of said paddle assembly, and optionally, a spring positioned between said cover and said paddle assembly, said body providing a portal for at least a portion of said paddle assembly to pass outwardly therethrough which further provides a governing means defining the range of motion of said paddle assembly; wherein, optionally, one paddle assembly is configured to shift to a higher gear, and another paddle assembly to downshift;
wherein said switch is configured and dimension to cooperatively function with said paddle assembly, and a transmitting means integrated with said body for communicating wirelessly with a receiving means cooperatively connected to the computer controlling the vehicle's transmission.

2. An improved transmission system as in claim 1, wherein said body further comprises a steering wheel adaptor ring releasably mounted to said body.

3. An improved transmission system as in claim 1, wherein said body is made from a material comprising the characteristics of aluminum.

4. An improved transmission system as in claim 1, wherein each assembly comprises a paddle portion and a hinge portion.

5. An improved transmission system as in claim 4, wherein said portions are separate interconnected parts.

6. An improved transmission system as in claim 5, wherein said paddle portions are interchangeable.

7. An improved transmission system as in claim 1, wherein said switch is a lever switch having a roller on the end of said lever.

8. An improved transmission system as in claim 1, wherein said switch has a plurality of positions, wherein a first position is a neutral position, and a second position is the activation position.

9. An improved transmission system as in claim 1, wherein each end of said spring is positioned in a recess, a first end positioned in a recess on the inside of said cover, and a second end positioned in a recess of said paddle assembly.

10. An improved transmission system as in claim 1, wherein said governing means provides a range of motion wherein at least one position is parallel to the plane of said body.

11. An improved transmission system as in claim 1, wherein said transmitting means includes a battery, and, optionally, a LED test light cooperatively connected together.

12. An improved transmission system as in claim 1, wherein said receiving means includes a switching means for selection of a driving mode comprising: automatic, and manu-matic.

13. An improved transmission system as in claim 1, wherein said paddle assemblies system, are configured and dimensioned to be about two (2) inches to about three-eighths (⅜) of an inch from a steering while in a neutral position.

14. An improved transmission system as in claim 1, wherein said paddle assemblies system, are configured and dimensioned to be about one (1) inch to about three-quarters (¾) of an inch from a steering while in a neutral position.

15. An improved transmission system as in claim 1, wherein said paddle assemblies system, are configured and dimensioned to control only forward gears while the vehicle is at speed.

16. An improved transmission system as in claim 1, wherein signal transmission time be limited to no more than about an eighth of a second (0.125 sec).

17. An improved transmission system as in claim 12, wherein said switching means is selected from the group consisting of: a lever switch, and a rocker switch.

18. An improved transmission system as in claim 1, wherein said paddle assemblies define the overall width of said system 1, which is preferably less than or equal to the overall width of the steering wheel to be utilized in cooperation therewith, and positioned about 180 degrees from each other.

19. An improved transmission system as in claim 1, wherein said paddle assemblies emanate from the central hub in a 9 o'clock and 3 o'clock position, and optionally, to the 10 o'clock and 2 o'clock positions.

20. An improved transmission system as in claim 1, wherein each said assembly comprises a paddle portion, and a hinge portion, optionally, these portions may optionally be separate and distinct parts that are interconnected together, preferably via threaded fasteners; further optionally, the paddle portions may also be interchangeable having different aesthetic features.

21. An improved transmission system as in claim 20, wherein each said assembly includes ergonomic elements of a leg section, a heel section, and a toe section.
